(19) United States
(12) Patent Application Publication
(10) Pub. No.: US 2021/0370763 A1
(43) Pub. Date: Dec. 2, 2021

(54) OPENING-CLOSING DEVICE FOR FUEL SUPPLY PASSAGE

(71) Applicant: TOYODA GOSEI CO., LTD., Kiyosu-shi (JP)

(72) Inventors: Ryan MAJEWSKI, Troy, MI (US); Steven YURGALONIS, Troy, MI (US)

(21) Appl. No.: 16/890,316

(22) Filed: Jun. 2, 2020

(51) Int. Cl. B60K 15/04

(52) U.S. Cl. CPC B60K 15/04; B60K 2015/0458

(57) ABSTRACT

An opening-closing device for a fuel supply passage includes a tubular passage forming portion having a fuel inlet port, a flap having an engagement portion, and an opening-closing actuating member. The opening-closing actuating member includes a main body and movable portions coupled to the main body. Each movable portion includes a proximal portion, an arm extending in the circumferential direction from the proximal portion, a nozzle detecting portion protruding inward in the radial direction from the arm, and an engaging portion. When the nozzle detecting portions do not receive a pushing force, the engaging portions are engaged with the engagement portion to lock the flap in a closing state in which the flap closes the fuel inlet port. When the nozzle detecting portions receive the pushing force, the engaging portions are disengaged outward in the radial direction from the engagement portion to unlock the flap.

### BACKGROUND

### 1. Field

The present disclosure relates to an opening-closing device for a fuel supply passage. The opening-closing device is configured to selectively open and close a fuel supply passage that conducts fuel supplied from a fuel nozzle to a fuel tank.

### 2. Description of Related Art

In some cases, fuel nozzles of different nozzle diameters, each corresponding to a different type of fuel, are used to prevent fuel that is different from the intended type from being supplied to the fuel tank of an automobile.

A fuel nozzle of a nozzle diameter corresponding to the fuel in the fuel tank is referred to as an intended-fuel nozzle, while a fuel nozzle of a nozzle diameter smaller than that of the intended-fuel nozzle is referred to as an unintended-fuel nozzle. When an intended-fuel nozzle and an unintended-fuel nozzle do not have to be distinguished, these are simply referred to as fuel nozzles.

The fuel supply passage for conducting fuel supplied from a fuel nozzle to a fuel tank is equipped with an opening-closing device that selectively opens and closes the fuel supply passage. For example, U.S. Pat. No. 8,714,214 discloses an opening-closing device that includes a tubular passage forming portion 61 having a fuel inlet port, a flap 62 for selectively opening and closing the fuel inlet port, and an opening-closing actuating member 63. The opening-closing actuating member 63 allows the flap 62 to open the fuel inlet port only when the fuel nozzle inserted into the passage forming portion 61 is an intended-fuel nozzle 70, which is represented by the long dashed double-short dashed line in FIG. 11. The flap 62 includes a plate-shaped engagement portion 64, which protrudes outward in the radial direction.

The opening-closing actuating member 63 includes an arcuate main body 65, which is arranged in the passage forming portion 61, and two movable portions 66, which are coupled to the opposite ends in the circumferential direction of the main body 65. Each movable portion 66 includes an arm 67, a nozzle detecting portion 68, and an engaging portion 69. The arms 67 extend away from each other in the circumferential direction from the opposite ends of the main body 65 and along the inner wall surface of the passage forming portion 61. Each nozzle detecting portion 68 protrudes inward in the radial direction of the passage forming portion 61 from the corresponding arm 67. Each engaging portion 69 protrudes toward the opposed arm 67 from the end of the arm 67 opposite from the main body 65.

When an unintended-fuel nozzle (not shown) is inserted into the passage forming portion 61 of the opening-closing device 60 described above, the nozzle detecting portions 68 do not receive pushing force acting outward in the radial direction from the unintended-fuel nozzle. In this case, the engaging portions 69 are engaged with the engagement portion 64 as indicated by the long dashed double-short dashed line in FIG. 11 to lock the flap 62 in a closing state, in which the flap 62 closes the fuel inlet port. The flap 62 restricts insertion of the unintended-fuel nozzle into the fuel inlet port. This prevents fuel that is different from the intended type from being inadvertently supplied to the fuel tank.

In contrast, When the intended-fuel nozzle 70, which is represented by the long dashed double-short dashed line in FIG. 11, is inserted into the passage forming portion 61, the nozzle detecting portions 68 receive a pushing force from the intended-fuel nozzle 70. The pushing force bends the arms 67 in directions indicated by arrows in FIG. 11. Accordingly, the engaging portions 69 move away from each other in the circumferential direction as indicated by the solid lines in FIG. 11 to be separated away from the engagement portion 64. This unlocks the flap 62, which is in tum allowed to open the fuel inlet port. The intended-fuel nozzle 70 is thus allowed to open the fuel inlet port by pushing the flap 62, so that fuel of the intended type can be supplied to the fuel tank through the fuel inlet port.

However, as the number of types of intended-fuel nozzles and unintended-fuel nozzles increases, the difference in nozzle diameter between the intended-fuel nozzle 70 and an unintended-fuel nozzle, which has to be detected by the nozzle detecting portions 68, can be significantly small. For example, the difference in nozzle diameter between a gasoline nozzle and a nozzle for AdBlue, which has been in use recently, is only 2 mm. Further, gasoline nozzles alone come in various nozzle diameters. Thus, the opening-closing device 60, which unlocks the flap 62 from the closing state, has a room for improvement in the detection accuracy.

### SUMMARY

It is an objective of the present disclosure to provide an opening-closing device for a fuel supply passage that improves the detection accuracy for nozzle diameters.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an opening-closing device for a fuel supply passage that conducts fuel supplied from a fuel nozzle to a fuel tank is provided. The opening-closing device is configured to selectively open and close the fuel supply passage and includes a tubular passage forming portion having a fuel inlet port, a flap that selectively opens and closes the fuel inlet port and includes an engagement portion, and an opening-closing actuating member. When the fuel nozzle inserted into the passage forming portion is an intended-fuel nozzle, which has a nozzle diameter corresponding to fuel in the fuel tank, the opening-closing actuating member allows the flap to open the fuel inlet port. When the fuel nozzle is an unintended-fuel nozzle, which has a nozzle diameter smaller than that of the intended-fuel nozzle, the opening-closing actuating member does not allow the flap to open the fuel inlet port. The opening-closing actuating member includes a main body disposed along an inner wall surface of the passage forming portion, and a plurality of movable portions coupled to the main body. Each movable portion includes a proximal portion, an arm, a nozzle detecting portion, and an engaging portion. The proximal portions of the movable portions protrude inward in a radial direction of the passage forming portion from different positions on the main body separated in a circumferential direction of the passage forming portion. Each arm extends in the circumferential direction from the corresponding proximal portion while being separated inward in the radial direction from an inner wall surface of the main body. Each nozzle detecting portion protrudes inward in the radial direction from the corresponding arm. Each engaging portion is provided at a position different from the nozzle detecting portion on the corresponding arm. When the nozzle detecting portions do not receive a pushing force acting outward in the radial direction from the intended-fuel nozzle, the engaging portions are engaged with the engagement portion to lock the flap in a closing state in which the flap closes the fuel inlet port. When the nozzle detecting portions receive the pushing force, the arms are bent so that the engaging portions are disengaged outward in the radial direction from the engagement portion to unlock the flap.

Other features and aspects will be apparent from the following detailed description, the drawings, and the claims.

### BRIEF DESCRIPTION OF THE DRAWINGS

FIG. 1 is an exploded perspective view of an opening-closing device according to an embodiment, illustrating a state before a capless assembly is attached to an outer tube member.

FIG. 2 is a longitudinal cross-sectional view of the opening-closing device of the embodiment.

FIG. 3A is a longitudinal cross-sectional view of the capless assembly removed from the opening-closing device of FIG. 2.

FIG. 3B is an enlarged longitudinal cross-sectional view showing section A in FIG. 3A.

FIG. 4 is a partial perspective view showing the relationship between an intended-fuel nozzle and the structure including an inner tube member, an opening-closing actuating member, and a flap.

FIG. 5 is an exploded perspective view showing main components of the capless assembly of the embodiment.

FIG. 6 is a plan view of the opening-closing actuating member of the embodiment.

FIG. 7 is a plan view of the opening-closing actuating member and the surrounding structure before a fuel nozzle is inserted into the passage forming portion.

FIG. 8 is a plan view of the opening-closing actuating member the surrounding structure when an unintended-fuel nozzle is inserted into the passage forming portion.

FIG. 9 is a plan view of the opening-closing actuating member and the surrounding structure when an intended-fuel nozzle is inserted into the passage forming portion.

FIG. 10 is a partial cross-sectional view corresponding to FIG. 3B, illustrating a state in which an engaging portion of the opening-closing actuating member is separated from an engagement portion of the flap.

FIG. 11 is a plan view showing an opening-closing actuating member and the surrounding structure in a conventional opening-closing device, together with an intended-fuel nozzle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

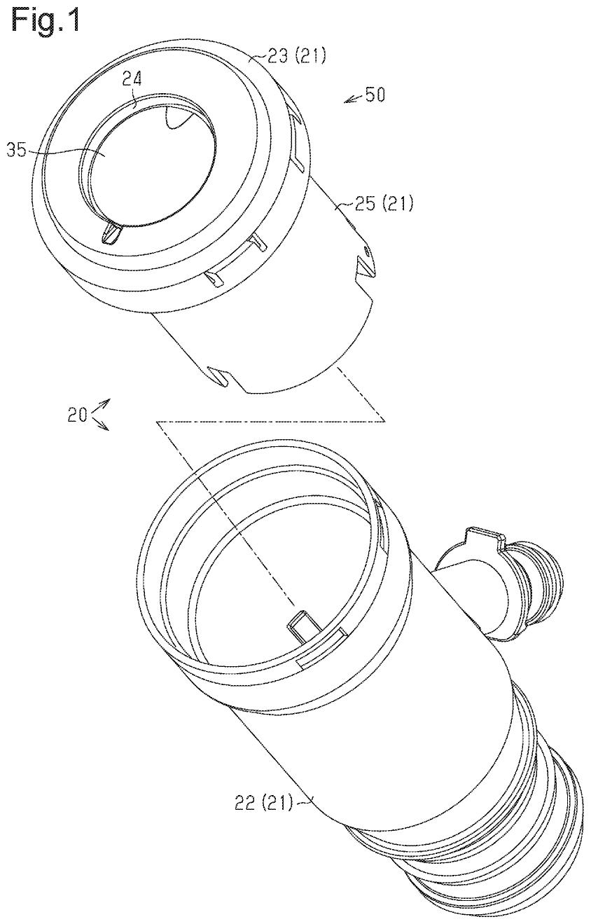

An opening-closing device 20 for a fuel supply passage according to an embodiment will now be described with reference to FIGS. 1 to 10.

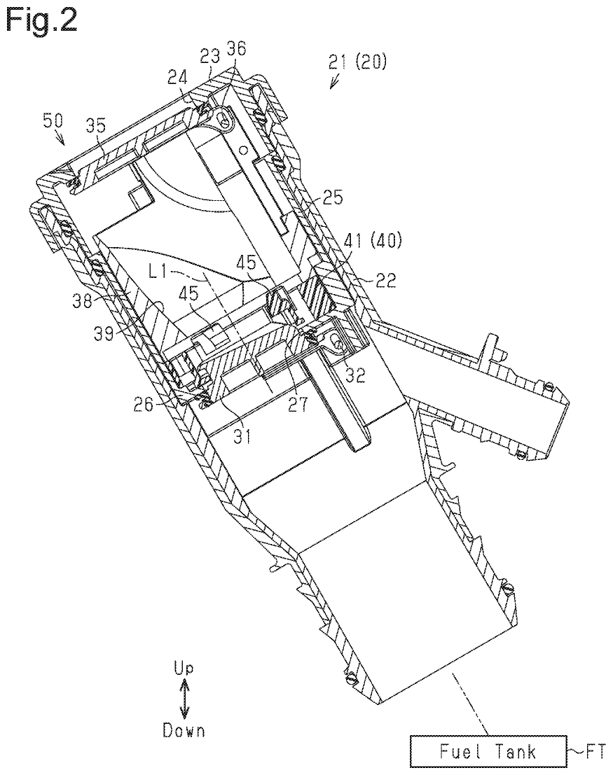

An automobile equipped with a diesel engine has a fuel tank (refer to FIG. 2) for storing diesel fuel. The body of the automobile includes a fuel supply passage, which conducts fuel supplied from a fuel nozzle to the fuel tank, and an opening-closing device 20, which selectively opens and closes the fuel supply passage.

Fuel nozzles of different nozzle diameters each corresponding to a different type of fuel are used to prevent fuel that is different from the intended type, gasoline in this example, from being supplied to the fuel tank via the fuel supply passage. A fuel nozzle of a nozzle diameter corresponding to the diesel fuel in the fuel tank is referred to as an intended-fuel nozzle, while a fuel nozzle of a nozzle diameter corresponding to gasoline is referred to as an unintended-fuel nozzle. When an intended-fuel nozzle and an unintended-fuel nozzle do not have to be distinguished, these are simply referred to as fuel nozzles.

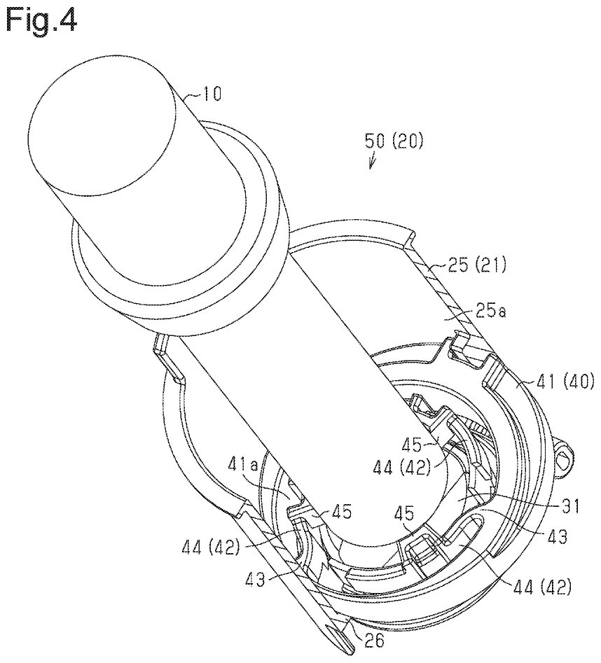

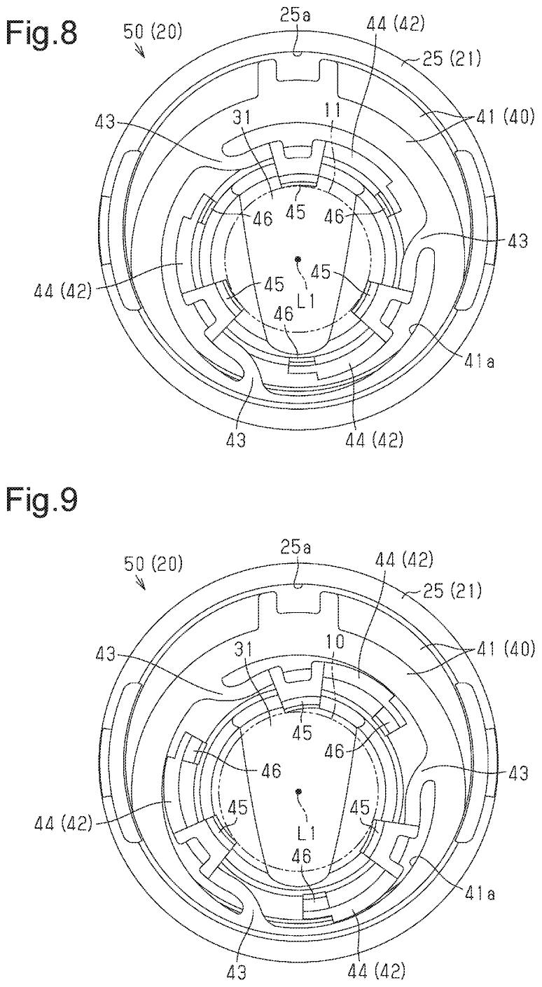

FIG. 4 illustrates a part of an intended-fuel nozzle 10. The long dashed double-short dashed line in FIG. 9 represents the intended-fuel nozzle 10. The long dashed double-short dashed line in FIG. 8 represents an unintended-fuel nozzle 11. The diameter of the intended-fuel nozzle 10 is set to be larger than the diameter of the unintended-fuel nozzle 11.

As shown in FIGS. 2, 3A, and 5, the opening-closing device 20 includes a passage forming portion 21, a flap 31, an inner cover 35, a nozzle guide 38, and an opening-closing actuating member 40.

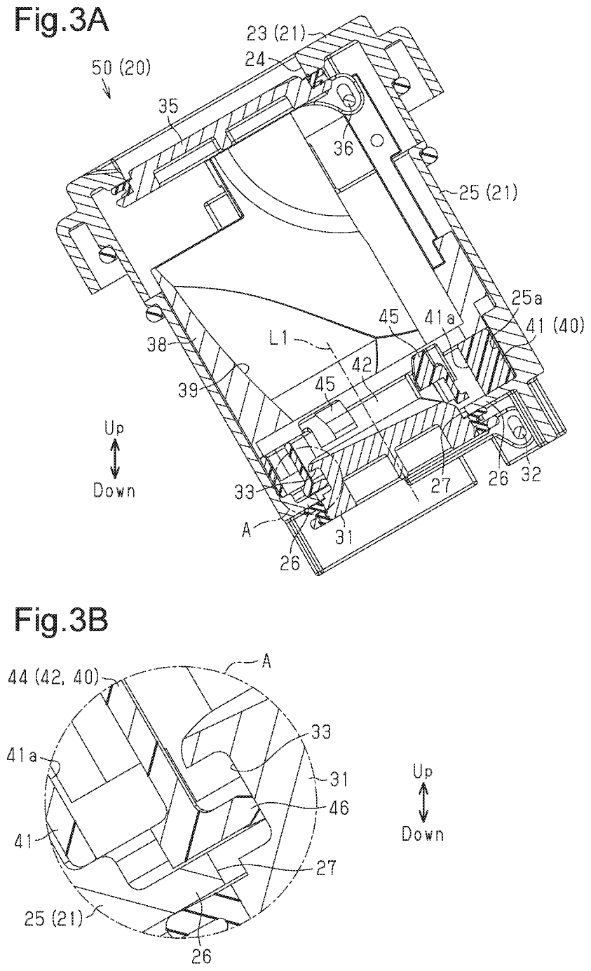

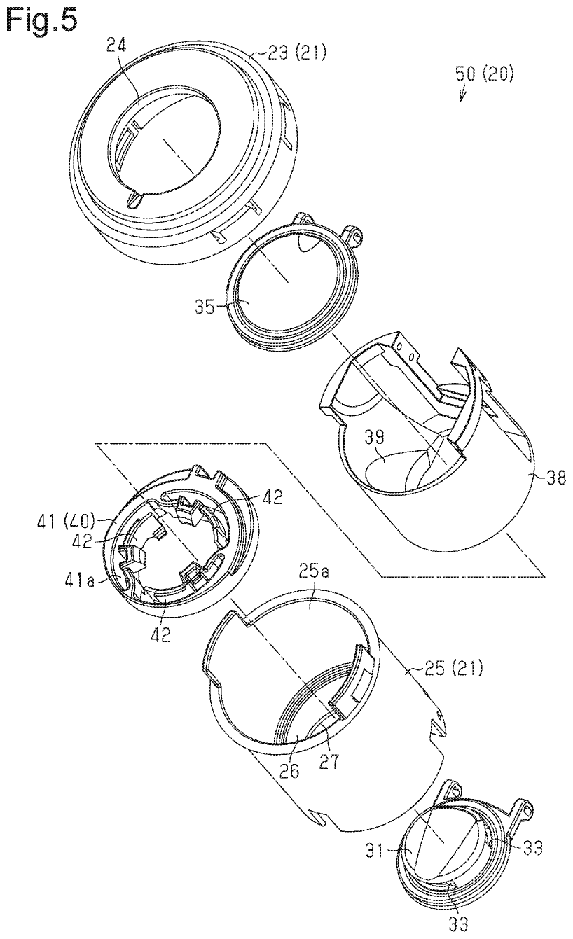

The passage forming portion 21 is constituted by assembling multiple components. More specifically, as shown in FIGS. 1 and 2, the passage forming portion 21 includes a substantially cylindrical outer tube member 22, of which the opposite ends are open, an outer cover 23, which is attached to the upper end of the outer tube member 22, and a substantially cylindrical inner tube member 25 having an open upper end and a closed lower end. The inner tube member 25 is disposed inside the outer tube member 22 and directly below the outer cover 23. The passage forming portion 21 incorporates a part of the fuel supply passage. The outer cover 23 has an insertion port 24, which is a circular hole the diameter of which is greater than the nozzle diameter of the intended-fuel nozzle 10. The outer cover 23 is thus substantially annular. As shown in FIGS. 3A, 3B, and 5, the inner tube member 25 has a fuel inlet port 27 in a bottom 26.

The flap 31 is arranged in the lower part of the inner tube member 25. The flap 31 is supported by the part of the inner tube member 25 that is below the bottom 26 with a lower shaft 32, which extends in a tangential direction of the inner tube member 25. The flap 31 has an engagement portion 33 in the periphery. The engagement portion 33 is constituted by a recess that is open in the outer circumferential surface of the flap 31. The flap 31 is allowed to pivot between a closing position (FIGS. 3A and 3B) and an opening position (not shown). In the closing position, the flap 31 is tilted to be lowered as the distance from the lower shaft 32 increases so as to close the fuel inlet port 27. In the opening position, the flap 31 is steeper than in the closing position so as to open the fuel inlet port 27. A lower spring (not shown) is attached to the lower shaft 32. The lower spring includes, for example, a torsion coil spring that constantly urges the flap 31 toward the closing position.

As shown in FIG. 2, the inner cover 35 and the nozzle guide 38 are disposed inside the outer tube member 22 and blow the outer cover 23. As shower FIGS. 2 and 5, the nozzle guide 38 has a substantially cylindrical shape with the upper and lower ends open. The nozzle guide 38 has an inclined surface 39 on the inner wall surface. The inclined surface 39 is curved in the circumferential direction and is tilted to be closer to a main body 41 (discussed below) of the opening-closing actuating member 40 toward the lower end. More specifically, the inclined surface 39 is tilted relative to a central axis L1 of the inner circumferential surface of the main body 41 of the opening-closing actuating member 40 so as to be closer to the central axis L1 toward the lower end. When inserted into the passage forming portion 21, the distal end of a fuel nozzle contacts the inclined surface 39 and is guided to approach the central axis L1.

The inner cover 35 restricts dust and rainwater from entering the passage forming portion 21 through the insertion port 24. As shown in FIGS. 2 and 3A, the inner cover 35 is supported by the upper end of the nozzle guide 38 with an upper shaft 36, which extends in a tangential direction of the nozzle guide 38. The upper shaft 36 extends parallel to the lower shaft 32 of the flap 31. The inner cover 35 is allowed to pivot between a closing position (FIGS. 2 and 3A) and an opening position (not shown). In the closing position, the inner cover 35 is tilted to be lowered as the distance from the upper shaft 36 increases so as to close the insertion port 24 by contacting the outer cover 23 from below. In the opening position, the inner cover 35 is steeper than in the closing position so as to open the insertion port 24. An upper spring (not shown) is attached to the upper shaft 36. The upper spring includes, for example, a torsion coil spring that constantly urges the inner cover 35 toward the closing position.

The opening-closing actuating member 40 allows the flap 31 to open the fuel inlet port 27 only when the fuel nozzle inserted into the passage forming portion 21 is the intended-fuel nozzle 10. The opening-closing actuating member 40 is disposed between the nozzle guide 38 and the bottom 26 of the inner tube member 25.

As shown in FIGS. 5 and 7, the opening-closing actuating member 40 includes the main body 41 and movable portions 42 coupled to the main body 41. The main body 41 is disposed along an inner wall surface 25a of the inner tube member 25, which constitutes a part of the passage forming portion 21. The main body 41 has an annular shape corresponding to the inner wall surface 25a of the inner tube member 25. The number of the movable portions 42 is three in the present embodiment. The main body 41 and the three movable portions 42 are formed integrally of plastic and is configured to be a component of the opening-closing actuating member 40.

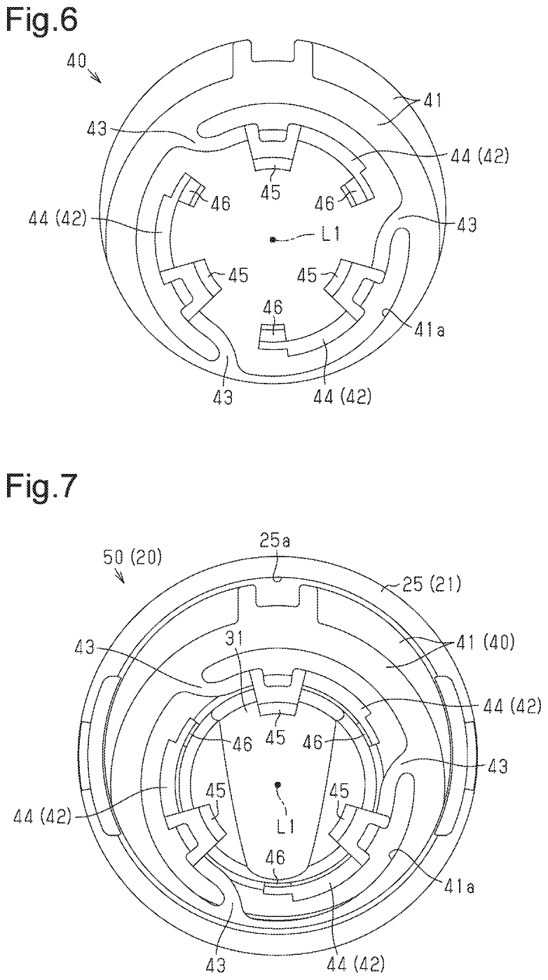

As shown in FIGS. 6 and 7, each movable portion 42 has a proximal portion 43, an arm 44, a nozzle detecting portion 45, and an engaging portion 46.

The proximal portions 43 of the respective movable portions 42 protrude inward in the radial direction of the passage forming portion 21 from different positions on the main body 41 separated. in the circumferential direction of the passage forming portion 21 (the inner tube member 25). In the present embodiment, the proximal portions 43 are provided at equal angular intervals (120°) about the central axis L1.

The arms 44 of the movable portions 42 are disposed in a plane orthogonal to the central axis L1. The arms 44 of the movable portions 42 are separated inward in the radial direction from the inner wall surface 41a of the main body 41. The arms 44 of the movable portions 42 extend in the circumferential direction along the inner wall surface 41a of the main body 41 from the proximal portions 43. The arms 44 are curved to bulge outward in the radial direction in correspondence with the inner wall surface 41a. Further, in the present embodiment, the arms 44 extend toward the same side in the circumferential direction of the inner tube member 25 and the main body 41.

The nozzle detecting portion 45 of each movable portion 42 is provided at the middle in the circumferential direction of the arm 44 and protrude inward in the radial direction from the arm 44. The distal end faces of the nozzle detecting portions 45 of the movable portions 42 are located on an imaginary circle the diameter of which is larger than the nozzle diameter of the unintended-fuel nozzle 11 and is smaller than the nozzle diameter of the intended-fuel nozzle 10.

The engaging portion 46 of each movable portion 42 is disposed at a position different from the nozzle detecting portion 45 of the arm 44. More specifically, the engaging portion 46 of each movable portion 42 is provided on the opposite side of the nozzle detecting portion 45 from the proximal portion 43. In the present embodiment, the engaging portion 46 of each movable portion 42 is located at the end opposite from the proximal portion 43 of the movable portion 42. The engaging portion 46 of each movable portion 42 protrudes inward in the radial direction from the arm 44.

When the nozzle detecting portions 45 do not receive a pushing force acting outward in the radial direction from the intended-fuel nozzle 10 as shown in FIGS. 7 and 8, the engaging portions 46 of the movable portions 42 are engaged with the engagement portion 33 as shown in FIGS. 3A and 3B to lock the flap 31 in the closing state, in which the flap 31 closes the fuel inlet port 27. The movable portions 42 are urged inward (toward the central axis L1) by urging members such as springs (not shown).

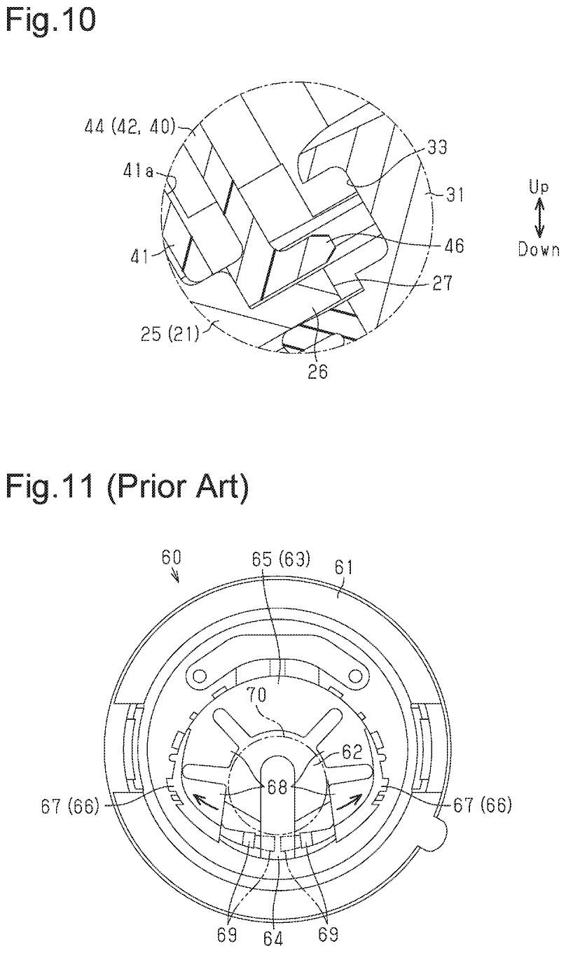

In contrast, when the nozzle detecting portions 45 receive a pushing force, the arms 44 are bent outward in the radial direction as shown in FIG. 9, so that the engaging portions 46 are disengaged from the engagement portion 33 as shown in FIG. 10 to unlock the flap 31.

In the present embodiment, a capless assembly 50 is constituted by assembling the outer cover 23, the inner tube member 25, the flap 31, the inner cover 35, the nozzle guide 38, and the opening-closing actuating member 40 together as shown in FIGS. 1 and 3A. The capless assembly 50 shown in FIGS. 1 and 2 is attached to the outer tube member 22 to constitute the opening-closing device 20.

An operation of the above-described embodiment will now be described. Advantages that accompany the operation will also be described.

When fuel is not supplied to a fuel tank FT, the inner cover 35 does not receive pushing force from a fuel nozzle as shown in FIGS. 2, 3A, and 3B. The inner cover 35, which is urged upward by the upper spring, closes the insertion port 24. This restricts entry of dust and rainwater outside the opening-closing device 20 into the passage forming portion 21 through the insertion port 24.

As shown in FIGS. 3B and 7, the nozzle detecting portions 45 of the opening-closing actuating member 40 do not receive a pushing force acting outward in the radial direction from a fuel nozzle. The engaging portions 46 of all the movable portions 42 are engaged with the engagement portion 33, so that the flap 31 is locked in the closing state, in which the flap 31 closes the fuel inlet port 27. At this time, the engaging portions 46 are engaged with the engagement portion 33 at multiple positions (three positions) that are largely separated away from each other in the circumferential direction of the main body 41. Particularly, in the present embodiment, the engagement is occurs at positions separated in the circumferential direction by equal angular intervals (120°). Thus, the present embodiment allows the flap 31 to be stably locked in the closing state as compared with the conventional opening-closing device 60 shown in FIG. 11, in which the engaging portions 69 are engaged with the engagement portion 64 at two positions that are close to each other in the circumferential direction of the opening-closing actuating member 63.

When fuel is supplied to the fuel tank FT shown in FIG. 2, the distal end of the intended-fuel nozzle 10 or the unintended-fuel nozzle 11 is pressed against the inner cover 35 shown in FIG. 3A from above. At this time, if the pushing force applied to the inner cover 35 exceeds the urging force of the upper spring, the inner cover 35 pivots downward about the upper shaft 36 against the urging force, so that the insertion port 24 is opened. As the amount of insertion of the fuel nozzle into the insertion port 24 increases, the inner cover 35 is tilted further to be steeper. The pivoting action of the inner cover 35 allows further insertion of the fuel nozzle. Through the insertion, the distal end of the fuel nozzle contacts the inclined surface 39 of the nozzle guide 38, so that the distal end of the fuel nozzle is guided toward the central axis L1 of the main body 41 of the opening-closing actuating member 40. At this time, the fuel nozzle is guided smoothly since the inclined surface 39 is curved in the circumferential direction of the nozzle guide 38. The distal end of the fuel nozzle is brought closer to the central axis L1. Accordingly, the nozzle guide 38 determines the position of the distal end of the fuel nozzle relative to the central axis L1.

If the thus positioned fuel nozzle is the unintended-fuel nozzle 11, the distal end does not contact or barely contacts the nozzle detecting portions 45 as indicated by the long dashed double-short dashed line in FIG. 8. In this state, the unintended-fuel nozzle 11 contacts the flap 31 after passing through the space surrounded by all the nozzle detecting portions 45. However, as shown in FIG. 3B, the engaging portions 46 of the arms 44 are engaged with the engagement portion 33, so that the flap 31 is locked in the closing state. Further, as described above, the flap 31 is locked in the closing state at multiple positions (three positions) in the periphery of the flap 31. Therefore, even if the flap 31 is pushed by the unintended-fuel nozzle 11, the flap 31 keeps being locked in the closing state and will not open the fuel inlet port 27. As a result, gasoline is prevented from being inadvertently supplied to the fuel tank FT from the fuel inlet port 27.

In contrast, if the nozzle inserted into the insertion port 24 is the intended-fuel nozzle 10, which supplies diesel fuel, the distal end of the intended-fuel nozzle 10 firmly and simultaneously contact all the nozzle detecting portions 45 as indicated by the long dashed double-short dashed line in FIG. 9. The contact applies a force acting outward in the radial direction to the nozzle detecting portions 45. The force is transmitted to the arms 44 of the movable portions 42 via the nozzle detecting portions 45. The arm 44 of each movable portion 42 is bent outward in the radial direction about the proximal portion 43. Accordingly, the engaging portion 46 of each arm 44, which is separated from the nozzle detecting portion 45 in the circumferential direction, is also moved outward in the radial direction. Then, the engaging portions 46, which have been engaged with the engagement portion 33 as shown in FIG. 3B, are disengaged outward in the radial direction from the engagement portion 33 as shown in FIG. 10. The engaging portions 46 of all the movable portions 42 are simultaneously disengaged from the engagement portion 33, so that the movable portions 42 unlock the flap 31 from the closing state.

In the present embodiment, each engaging portion 46 is located at the end opposite from the proximal portion 43 of the movable portion 42, that is, at the farthest possible position from the proximal portion 43. Thus, the range of movement of the engaging portions 46 is larger than in a case in which the engaging portions 46 are located at positions closer to the nozzle detecting portions 45 than to the ends.

Then, the unlocking action allows the flap 31 to pivot from the closing position to the opening position.

The intended-fuel nozzle 10 is inserted further, the distal end is pushed against the upper surface of the flap 31. If the pushing force applied to the flap 31 exceeds the urging, force of the lower spring, the flap 31 pivots downward about the lower shaft 32 against the urging force. The pivoting, action opens the fuel inlet port 27, allowing the intended-fuel nozzle 10 to be inserted into the fuel inlet port 27. This allows for supply of diesel fuel to the fuel tank FT from the intended-fuel nozzle 10 through the fuel inlet port 27.

When the fueling is complete and the intended-fuel nozzle 10 is pulled to be removed from the fuel inlet port 27. the urging force of the lower spring in a direction urging the flap 31 in the closing direction causes the flap 31 to pivot upward, so as to close the fuel inlet port 27. As the intended-fuel nozzle 10 is pulled further, the force acting outward in the radial direction on the nozzle detecting portions 45 of the movable portions 42 from the intended-fuel nozzle 10 decreases. The arms 44 of the movable portions 42 are elastically deformed inward in the radial direction about the proximal portions 43 by the elastic restoring force of the arms 44. This moves the engaging portions 46 of the movable portions 42 inward in the radial direction. Then, the engaging portions 46. which have been disengaged from the engagement portion 33 as shown in FIG. 10, enter the engagement portion 33 so as to be engaged with the engagement portion 33 as shown in FIG. 3B. The engagement locks the flap 31 in the closing state. The flap 31 is stably locked at multiple positions (three positions) in the periphery of the flap 31.

As the intended-fuel nozzle 10 is pulled further, the force with which the distal end of the intended-fuel nozzle 10 pushes the inner cover 35 decreases. Accordingly, the urging force of the upper spring, which urges the inner cover 35 in the closing direction causes the inner cover 35 to pivot from the opening position toward the closing position. When the intended-fuel nozzle 10 is entirely pulled out from the insertion port 24, the force with which the intended-fuel nozzle 10 pushes the inner cover 35 is eliminated, so that the inner cover 35 closes the insertion port 24. The opening-closing device 20 returns to the state in which fuel is not supplied to the fuel tank FT, that is, the initial state. This also applies to a case in which the unintended-fuel nozzle 11 is pulled out from the insertion port 24.

In addition to the ones listed above, the present embodiment has the following advantages.

The inner cover 35, which opens and closes the insertion port 24, is supported by the nozzle guide 38, and the flap 31. which opens and closes the fuel inlet port 27. is supported by the inner tube member 25. Thus, as compared with a type of fuel cap that is screwed to be removed, the opening-closing device 20 of the present embodiment is easy to handle since there is no need to find a place to put the removed cap during fueling.

In the present embodiment, the multiple (three) proximal portions 43 are provided at equal angular intervals about the central axis L1. This uniformizes the load required to bend the arms 44 of the movable portions 42 outward in the radial direction and toward the same side in the circumferential direction in the plane orthogonal to the central axis L1, and thus facilitates insertion of the intended-fuel nozzle 10.

In the present embodiment, all the arms 44 are disposed in a plane orthogonal to the central axis L1 of the main body 41. All the movable portions 42 are bent or moved in this plane. This allows the size of the opening-closing actuating member 40 to be reduced in the radial direction of the passage forming portion 21. In other words, the opening-closing actuating member 40 can be made compact.

The opening-closing actuating members 40, 63 are formed by filling a mold with molten plastic. In the conventional opening-closing device 60, the main body 65 and the two movable portions 66 are integrated in the circumferential direction of the passage forming portion 61. Thus, the regulation of the flow of molten plastic during molding must be performed simultaneously for the main body 65 and both of the movable portions 66. This makes the regulation difficult. However, in the present embodiment, the main body 41 has an annular shape, and the movable portions 42 branch off the main body 41 at the proximal portions 43 protruding inward in the radial direction. The movable portions 42 are disposed independently from the main body 41. This arrangement allows the flow of molten plastic to be regulated separately for the main body 41 and the movable portions 42 with the proximal portions 43 serving as a boundary. This facilitates the regulation and improves the accuracy of the formation of the respective movable portions 42. That is, molding variations of the nozzle detecting portions 45 are reduced. As a result, even if the difference in nozzle diameter between the intended-fuel nozzle 10 and the unintended-fuel nozzle 11 is significantly small, the intended-fuel nozzle 10 is accurately detected. In other words, false detection is reduced. In addition, even in a case in which the nozzle detecting portions 45 are provided at three positions to improve the detection accuracy, the molding variations are limited, and thus the same advantages are achieved.

The arms 44 of the movable portions 42 extend toward the same side in the circumferential direction of the main body 41. Therefore, when molten plastic is injected into the mold, the molten plastic flows into the molding sections that mold the respective movable portions 42 in similar manners. The number of the molding sections is the same as the number of the movable portions 42, the molten plastic is allowed to flow uniformly in all the molding sections. As a result, the movable portions 42 are molded accurately. In other words, the molding accuracy of the movable portions 42 is improved

in the conventional opening-closing device 60, the two movable portions 66 extend away from each other in the circumferential direction of the passage forming portion 61 in relation to the main body 65. During plastic molding, the direction in which molten plastic flows differs between the molding sections for the movable portions 66. The flowability of molten plastic differs between the molding sections, which may reduce the molding accuracy.

The use of the nozzle guide 38 allows the distal end of the fuel nozzle to approach the central axis L1 of the main body 41 in the opening-closing actuating member 40. The fuel nozzle is allowed to simultaneously contact all the three nozzle detecting portions 45 to actuate all the three movable portions 42 simultaneously. The operator does not have to adjust the insertion position of the fuel nozzle and thus can easily perform insertion.

In the present embodiment, only one component (the opening-closing actuating member 40) is required to implement the function of allowing the flap 31 to open the fuel inlet port 27 only when the fuel nozzle inserted into the passage forming portion 21 is the intended-fuel nozzle 10. As compared with a case in which the same function is implemented by multiple components, the present embodiment reduces the number of components of the opening-closing device 20 and simplifies the structure.

The above-described embodiment may be modified as follows. The above-described embodiment and the following modifications can be combined as long as the combined modifications remain technically consistent with each other.

The number of the movable portions 42 in the opening-closing actuating member 40 may be changed to two or more than three. In either case, the proximal portions 43 are preferably provided at equal angular intervals about the central axis L1 of the main body 41. Also, the arms 44 preferably extend toward the same side in the circumferential direction of the main body 41.

However, the above conditions are optional. The proximal portions 43 do not necessarily need to be provided at equal angular intervals about the central axis L1. Also, one or two of the arms 44 may extend toward the opposite side in the circumferential direction from the side toward which the remaining arms 44 extend.

The engaging portion 46 of each movable portion 42 may be disposed at a position different from the distal end of the arm 44. In this case, the engaging portion 46 is preferably provided on the opposite side of the nozzle detecting portion 45 from the proximal portion 43. However, the engaging portion 46 may be provided between the proximal portion 43 and the nozzle detecting portion 45.

The shape of the main body 41 of the opening-closing actuating member 40 may be changed to a non-annular shape as long as the main body 41 is bent along the passage forming portion 21, for example, the inner wall surface 25a of the inner tube member 25.

The intended-fuel nozzle and the unintended-fuel nozzle are assumed to be a diesel fuel nozzle, a gasoline nozzle, and an AdBlue nozzle, but are not limited to these.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An opening-closing device for a fuel supply passage that conducts fuel supplied from a fuel nozzle to a fuel tank, the opening-closing device being configured to selectively open and close the fuel supply passage and comprising:
a tubular passage forming portion having a fuel inlet port;
a flap that selectively opens and closes the fuel inlet port and includes an engagement portion; and
an opening-closing actuating member, wherein
when the fuel nozzle inserted into the passage forming portion is an intended-fuel nozzle, which has a nozzle diameter corresponding to fuel in the fuel tank, the opening-closing actuating member allows the flap to open the fuel inlet port,
when the fuel nozzle is an unintended-fuel nozzle, which has a nozzle diameter smaller than that of the intended-fuel nozzle, the opening-closing actuating member does not allow the flap to open the fuel inlet port,
the opening-closing actuating member includes
a main body disposed along an inner wall surface of the passage forming portion, and
a plurality of movable portions coupled to the main body,
each movable portion includes a proximal portion, an arm, a nozzle detecting portion, and an engaging portion,
the proximal portions of the movable portions protrude inward in a radial direction of the passage forming portion from different positions on the main body separated in a circumferential direction of the passage forming portion,
each arm extends in the circumferential direction from the corresponding proximal portion while being separated inward in the radial direction from an inner wall surface of the main body,
each nozzle detecting portion protrudes inward in the radial direction from. the corresponding arm,
each engaging portion is provided at a position different from the nozzle detecting portion on the corresponding arm,
when the nozzle detecting portions do not receive a pushing force acting outward in the radial direction from the intended-fuel nozzle, the engaging portions are engaged with the engagement portion to lock the flap in a closing state in which the flap closes the fuel inlet port, and
when the nozzle detecting portions receive the pushing force, the arms are bent so that the engaging portions are disengaged outward in the radial direction from the engagement portion to unlock the flap.

2. The opening-closing device for a fuel supply passage according to claim 1, wherein
the main body has an annular shape,
the arms are disposed in a plane orthogonal to a central axis of the main body, and
the arms extend toward a same side in a circumferential direction of the main body.

3. The opening-closing device for a fuel supply passage according to claim 2, wherein the proximal portions are provided at equal angular intervals about the central axis of the main body.

4. The opening-closing device for a fuel supply passage according to claim 3, wherein the engaging portion of each movable portion is located at an end opposite from the proximal portion of the movable portion.

5. The opening-closing device for a fuel supply passage according to claim 4, wherein
the engagement portion is provided in a periphery of the flap, and
the engaging portion of each movable portion protrudes inward in the radial direction from the arm.

6. The opening-closing device for a fuel supply passage according to claim 2, wherein
a nozzle guide is disposed on an opposite side of the opening-closing actuating member from the flap, and
the nozzle guide is configured such that, when the fuel nozzle is inserted into the passage forming portion and contacts the nozzle guide, the nozzle guide causes a distal end of the fuel nozzle to approach the central axis.
